(19) United States
(12) Patent Application Publication
(10) Pub. No.: US 2010/0043262 A1
(43) Pub. Date: Feb. 25, 2010

(54) Card Holder

(75) Inventors: Patrick O'Brien, Providence, RI (US); John O'Mara, Norton, MA (US); David Kamyk, Worcester, MA (US)

Correspondence Address: FISH & RICHARDSON PC, P.O. BOX 1022, MINNEAPOLIS, MN, 55440-1022, US

(73) Assignee: Hub Folding Box Company, Inc.

(21) Appl. No.: 12/196,056

(22) Filed: Aug. 21, 2008

(51) Int. Cl. G09F 1/06; G09F 1/00

(52) U.S. Cl. 40/124.06; 40/124.08

(57) ABSTRACT

A card holder is disclosed which has: a) a front and a back panel connected by a central hinge; the holder having a closed position in which the front panel at least partially overlies the back panel, generally in a single plane, and an open position in which the panels are pivoted about the central hinge for viewing material positioned between the panels; and b) a pop-up connected to both panels, the pop-up panel being connected to at least one of the panels by a foldable extension. Opening the holder along the central hinge unfolds the foldable extension rotating the pop-up panel and moving the pop-up out of the plane of the panels.

### BACKGROUND

This invention relates to pockets for containing flat items such as gift cards or credit cards.

It is desirable to present a flat item such as a gift or credit card in an attractive manner, so as to peak the recipient's interest, while at the same time providing a safe and secure card holder.

### SUMMARY

In general, one aspect of the invention features
a) a front and a back panel connected by a central hinge; the holder having a closed position in which the front panel at least partially overlies the back panel, generally in a single plane, and an open position in which the panels are pivoted about the central hinge for viewing material positioned between the panels;
b) a pop-up connected to both panels, the pop-up panel being connected to at least one of the panels by a foldable extension;
whereby opening the holder along the central hinge unfolds the foldable extension rotating the pop-up panel and moving the pop-up out of the plane of the panels.

In preferred embodiments of this aspect, the pop-up is connected to one of the panels by the foldable extension and to the other panel by a hinge fold that is transverse to the central hinge. The foldable extension is connected to the pop-up along a line that is generally parallel to the central hinge. The front panel, the back panel, or both is a two thickness panel created by folding one or more blanks. The card holder can be made from a single blank, folded and glued to create the front panel, the back panel, the pop-up, the first connection and the second connection. One or both of the panels includes a pocket formed by folding a blank and leaving at least a portion of one edge of the panels open as an entrance to a space formed between the blanks. One of the panels has an edge transverse to the central hinge, and the panel is sized to expose at least some of a card positioned on the pop-up when the card holder is closed. A temporary seal holds the card holder in the closed position, and the seal is removed or broken to open the card holder.

The card holder thus provides a simple and attractive way to present a gift or other card, e.g., as a present. A corner of the card is visible in the closed position, reducing the chance that the holder and card will be discarded inadvertently. There is a place for a message, for example promotional material related to the card.

The card holder may be manufactured from a single blank by folding and gluing operations. These operations may be done in a single pass or in multiple passes.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a view of a card holder in the open position.

FIG. 2 is a view of the card holder of FIG. 1, in a closed position.

FIG. 3 is the open card of FIG. 1 viewed from the rear.

FIG. 4 is a view of a blank from which the card holder is manufactured.

FIG. 5 is a view of the card holder, partially open.

Like reference symbols in the various drawings indicate like elements.

### DETAILED DESCRIPTION

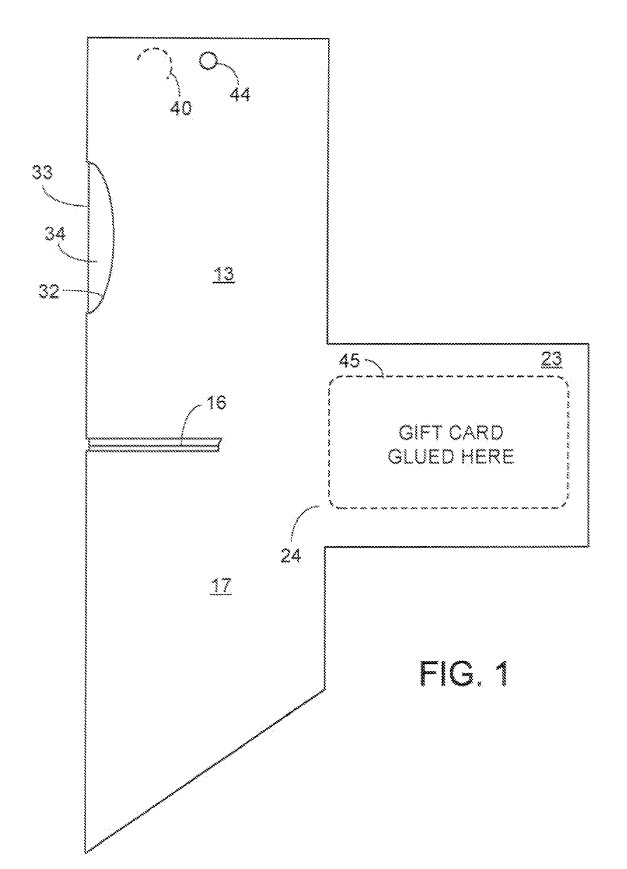

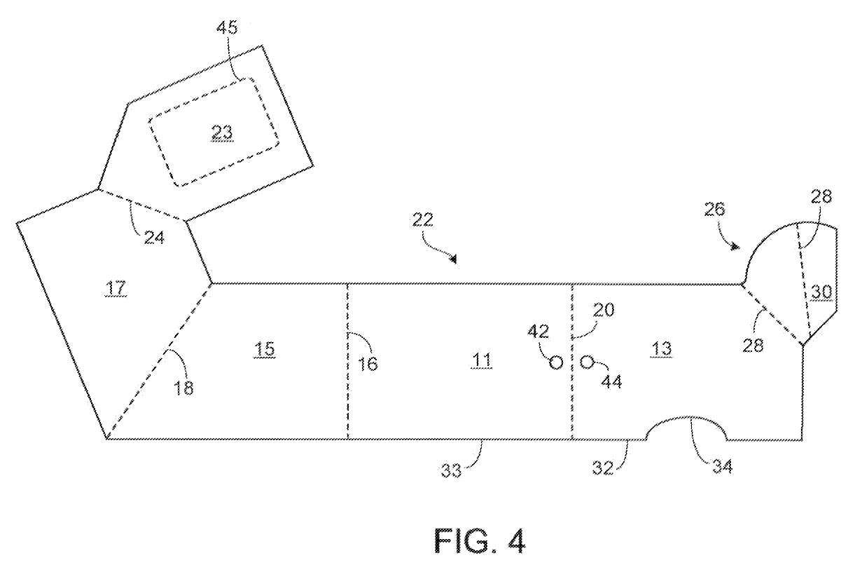

In FIG. 1, card holder 10 includes two double thickness walls 12 and 14, hinged along mid-line 16. Edges 18 and 20 are smooth edges. Edge 18 is formed by folding panels 15 and 17 of blank 22 (FIG. 4) on each other so that panel 15 is on the outside and panel 17 is on the inside of holder 10. Edge 20 is formed by folding panels 11 and 13 of blank 22 on each other, so that panel 11 is on the outside and panel 13 is on the inside of holder 10.

Panel 17 includes an extension 23, hinged to the remainder of panel 17 at hinge line 24. A card is glued onto the inward face of extension 23 as shown by a dotted line 45.

Panel 13 includes an extension 26 which is folded along hinge line 28 at its attachment to the remainder 29 of panel 13. Extension 26 includes a medial fold line 28 which provides a gluing surface 30 for attachment to the reverse side of extension 23. When folded, a corner of extension 23 is exposed, revealing a corner of the card positioned thereon. As the holder is unfolded along mid-line 16, extension 23 is drawn upwardly, at right angles to its position in the closed card, by the nature of the attachment between extension 23 and extension 26.

Edges 32 and 33 of panels 11 and 13 are not glued, creating a pocket 33 between panels 11 and 13. An arcuate cut-out 34 provides access to pocket 33.

A removable seal 40 attaches panel 15 to panel 13 to keep the holder in a closed position.

Holes 42 and 44 in panels 11 and 13, respectively align so that multiple holders may be hung in a display.

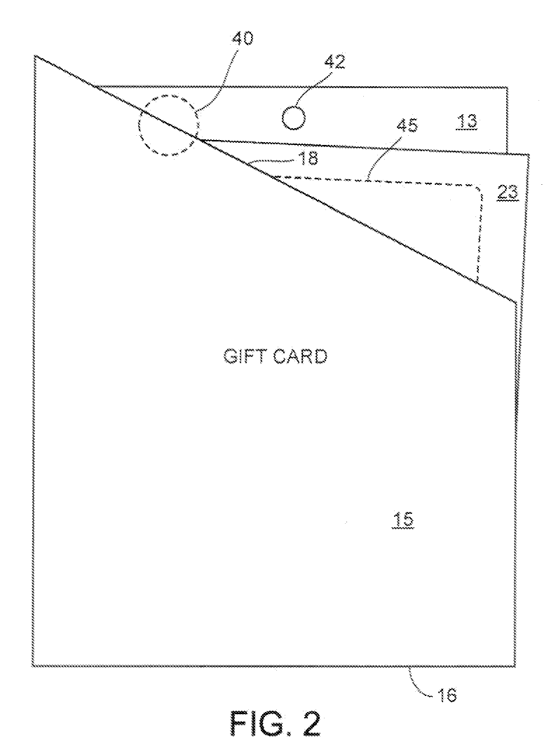

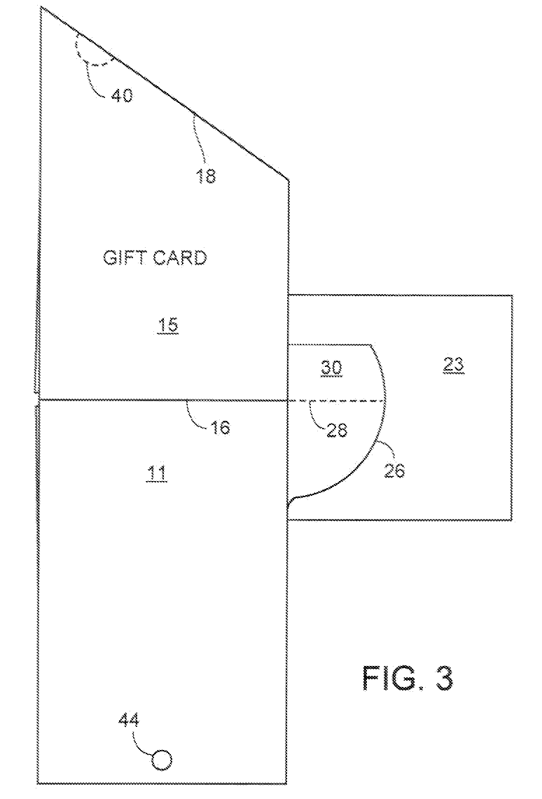

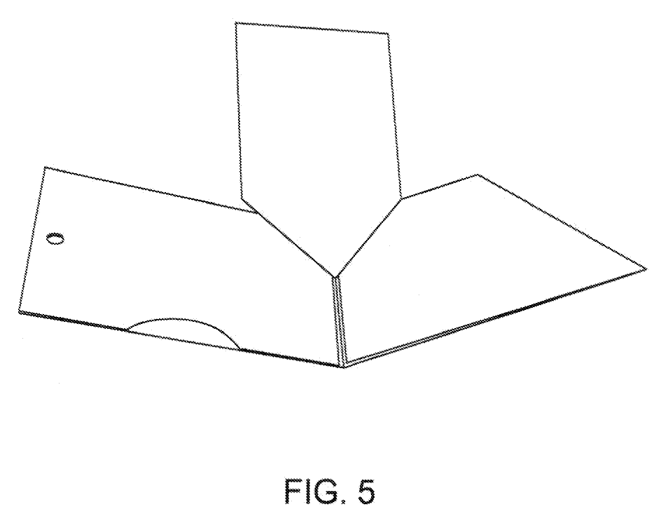

When seal 40 is broken or removed, holder 10 may be opened. Tension between extension 23 and extension 26 rotates extension 23 and moves it upward, causing it to pop out of the plane of the folded card. FIGS. 2 and 3 show the front and back of the card holder in the open position. FIG. 5 shows the card holder partially open.

Promotional or other printed material may be inserted in pocket 33.

To manufacture holder 10, a blank cut to the form shown in FIG. 4 is created with fold lines. The blank is folded and glued to create holder 10. Specifically (although not necessarily in this order and not necessarily as separate steps), panels 15 and 17 are folded and glued together. Panels 11 and 13 are glued together at all edges except at edges 32 and 33. Gluing surface 30 of extension 26 is glued to the reverse side of extension 23. The card (not shown) is glued to extension 23 in the position shown by dotted line 45. Printed material is inserted in pocket 33. The card is folded to the form shown in FIG. 1. Seal 40 is applied to maintain the card in the closed position.

The above folding and gluing operations may be accomplished in separate passes or on a single pass operation.

A number of embodiments of the invention have been described. Nevertheless, it will be understood that various modifications may be made without departing from the spirit and scope of the invention. Accordingly, other embodiments are within the scope of the following claims.

What is claimed is:

1. A card holder comprising
a) a front and a back panel connected by a central hinge; the holder having a closed position in which the front panel at least partially overlies the back panel, generally in a single plane, and an open position in which the panels are pivoted about the central hinge for viewing material positioned between the panels;
b) a pop-up connected to both panels, the pop-up panel being connected to at least one of the panels by a foldable extension;
whereby opening the holder along the central hinge unfolds the foldable extension rotating the pop-up panel and moving the pop-up out of the plane of the panels.

2. The card holder of claim 1 in which the pop-up is connected to one of the panels by the foldable extension and to the other panel by a hinge fold that is transverse to the central hinge.

3. The card holder of claim 2 in which the foldable extension is connected to the pop-up along a line that is generally parallel to the central hinge.

4. The card holder of claim 1 in which the front panel, the back panel, or both is a two thickness panel created by folding one or more blanks.

5. The card holder of claim 1 in which the card holder is a single blank, folded and glued to create the front panel, the back panel, the pop-up, the first connection and the second connection.

6. The card holder of claim 4 in which one or both of the panels includes a pocket formed by folding a blank and leaving at least a portion of one edge of the panels open as an entrance to a space formed between the blanks.

7. The card holder of claim 1 in which one of the panels has an edge transverse to the central hinge, and the panel is sized to expose at least some of a card positioned on the pop-up when the card holder is closed.

8. The card holder of claim 1 in which a temporary seal holds the card holder in the closed position, and the seal is removed or broken to open the card holder.
